(19) United States
(12) Patent Application Publication
(10) Pub. No.: US 2011/0170814 A1
(43) Pub. Date: Jul. 14, 2011

(54) STABILIZER BUSHING

(75) Inventors: Yorikazu Nakamura, Kasugai-shi (JP); Kenichi Kato, Komaki-shi (JP); Keisuke Miwa, Toyota-shi (JP)

(73) Assignees: TOKAI RUBBER INDUSTRIES, LTD., Komaki-shi, Aichi-ken (JP); TOYOTA JIDOSHA KABUSHIKI KAISHA, Toyota-shi, Aichi-ken (JP)

(21) Appl. No.: 13/054,280

(22) PCT Filed: Sep. 29, 2009
(86) PCT No.: PCT/JP2009/066968

§ 371 Date: Jan. 14, 2011

(30) Foreign Application Priority Data
Sep. 30, 2008 (JP) 2008-254950

(51) Int. Cl. F16F 15/08; F16C 33/22

(52) U.S. Cl. 384/125

(57) ABSTRACT

A stabilizer bushing wherein there is low friction resistance between the stabilizer bushing and a stabilizer bar, and a coating film is not prone to separation from a rubber elastic body. Stabilizer bushings include: a rubber elastic body that is made of a self-lubricating rubber containing an elastomer and a bleeding lubricant, that includes a holding hole that holds a stabilizer bar on a radial inner side, and that is shaped as a cylinder attached to a body of a vehicle by brackets, a coating film that covers an inner circumferential surface of the holding hole, that contains a resin having a mercapto group, and that is deformable to follow up deformation of the rubber elastic body; and a lubricating film that is formed on a surface of the coating film by the bleeding lubricant of the rubber elastic body penetrating the coating film and oozing onto the surface of the coating film, and that is in relative sliding contact with an outer circumferential surface of the stabilizer bar.

### TECHNICAL FIELD

The present invention relates to a stabilizer bushing that is interposed between a stabilizer bar and a bracket attached to a body of a vehicle, and that suppresses the transmission of vibrations from the stabilizer bar to the body.

### BACKGROUND ART

FIG. 6 shows a schematic diagram of a suspension of a vehicle. Note that a state before turning is shown by a thinner line, while a state during turning is shown by a regular solid line. As FIG. 6 shows, stabilizer bushings 700L, 700R are fixed to a body (not shown) of a vehicle through brackets 701L, 701R. A stabilizer bar 703 is disposed in holding holes 702L, 702R of the stabilizer bushings 700L, 700R.

For example, when the vehicle turns left, a centrifugal force causes a front wheel 704R on the right side (outer wheel side) to sink downward with respect to a front wheel 704L on the left side (inner wheel side), as shown in FIG. 6. This twists the stabilizer bar 703 in the counterclockwise direction as viewed from the left in the figure. Utilizing an elastic restoring force against such torsion, the stabilizer bar 703 suppresses rolling of the vehicle during turning.

When the stabilizer bar 703 is twisted or when the twisted stabilizer bar 703 recovers due to the elastic restoring force, the outer circumferential surface of the stabilizer bar 703 and the inner circumferential surfaces of the holding holes 702L, 702R slide relative to one another. Higher friction resistance during such sliding may cause more abnormal noise (a so-called stick slip noise), and may reduce the riding comfort of the vehicle.

In view of these points, a liner made of polytetrafluoroethylene (PTFE) with a small friction coefficient is conventionally inserted into the holding holes 702L, 702R. The inner circumferential surface of the liner and the outer circumferential surface of the stabilizer bar 703 then slidingly contact one another. However, the PTFE liner is relatively expensive. Therefore, if the PTFE liner is used, the cost of manufacturing the stabilizer bushings 700L, 700R increases.

Hence, stabilizer bushings that do not require a PTFE liner have been developed. For example, Patent Document 1 describes a stabilizer bushing that has a rubber elastic body made of a self-lubricating rubber. The rubber elastic body is provided with a holding hole, and the stabilizer bar is disposed in the holding hole. According to the stabilizer bushing of Patent Document 1, a fatty acid amide that comprises a component of the self-lubricating rubber oozes onto the inner circumferential surface of the holding hole, thereby reducing the friction resistance between the stabilizer bushing and the stabilizer bar.

Patent Document 2 describes a stabilizer bushing that includes a rubber elastic body made of a self-lubricating rubber, and a lubricant. The rubber elastic body is provided with a holding hole, and the stabilizer bar is disposed in the holding hole. The inner circumferential surface of the holding hole is formed with grid-like ribs. The lubricant is held in recess portions formed between the grid-like ribs. An ability to retain the lubricant is increased by the recess portions functioning as lubricant reservoir portions. According to the stabilizer bushing of Patent Document 2, the lubricant can be continuously and smoothly supplied between the stabilizer bushing and the stabilizer bar. Therefore, the friction resistance between the stabilizer bushing and the stabilizer bar can also be reduced. It should be noted that, in paragraph [0026] of Patent Document 2, a dry coating film that contains particles having a lubricating property such as molybdenum particles is disclosed as an example of the lubricant.

### PRIOR ART DOCUMENTS

### Patent Documents

Patent Document 1: Japanese Patent Application Publication No. JP-A-H05-255519
Patent Document 2: Japanese Patent Application Publication No. JP-A-2006-273181

### DISCLOSURE OF THE INVENTION

### Problem to be Solved by the Invention

However, in the case of the stabilizer bushing according to Patent Document 1, the adoption of a self-lubricating rubber alone does not necessarily guarantee that the friction resistance between the stabilizer bushing and the stabilizer bar will be reduced to a satisfactory level.

In the case of the stabilizer bushing according to Patent Document 2, the inner circumferential surface of the holding hole must be formed with the grid-like ribs, thus making the shape of the inner circumferential surface more complex. If a dry coating film covers the inner circumferential surface of the holding hole of the rubber elastic body made of a self-lubricating rubber, the bleeding lubricant oozing from the rubber elastic body causes the dry coating film to be more prone to separation from the inner circumferential surface of the holding hole. And the operation itself to dispose the dry coating film on the inner circumferential surface of the holding hole from which the bleeding lubricant oozes is difficult. On this point, there is no specific description in Patent Document 2 regarding the method of disposing the dry coating film on the inner circumferential surface of the holding hole.

A stabilizer bushing according to the present invention was accomplished in view of the foregoing problems. Thus, it is an object of the present invention to provide a stabilizer bushing wherein there is low friction resistance between the stabilizer bushing and an outer circumferential surface of a stabilizer bar, and a coating film is not prone to separation from a rubber elastic body.

### Means for Solving the Problem

(1) In order to solve the above problems, a stabilizer bushing is characterized by including: a rubber elastic body that is made of a self-lubricating rubber containing an elastomer and a bleeding lubricant, that includes a holding hole that holds a stabilizer bar on a radial inner side, and that is shaped as a cylinder attached to a body of a vehicle by a bracket; a coating film that covers an inner circumferential surface of the holding hole, that contains a resin having a mercapto group, and that is deformable to follow up deformation of the rubber elastic body; and a lubricating film that is formed on a surface of the coating film by the bleeding lubricant of the rubber elastic body penetrating the coating film and oozing onto the surface of the coating film, and that is in relative sliding contact with an outer circumferential surface of the stabilizer bar (equivalent to claim 1).

The stabilizer bushing of the present invention includes the rubber elastic body, the coating film, and the lubricating film. Among these, the lubricating film is in sliding contact with the stabilizer bar. In cases where there is a portion with insufficient lubricating film on the sliding interface between the stabilizer bushing and the stabilizer bar, the coating film containing the bleeding lubricant is exposed from this portion and comes into sliding contact with the stabilizer bar. Therefore, according to the stabilizer bushing of the present invention, primarily the lubricating film and supplementary the coating film are in sliding contact with the stabilizer bar. In addition, the rubber elastic body is not in sliding contact with the stabilizer bar. Thus, there is low friction resistance between the stabilizer bushing and the stabilizer bar.

A mercapto group (—SH) is introduced to the resin that forms the coating film. The mercapto group is a functional group with high reactivity towards an elastomer. Thus, according to the stabilizer bushing of the present invention, the rubber elastic body and the coating film can be strongly joined (chemically bonded). Therefore, the coating film is not prone to separation from the rubber elastic body. The coating film also easily deforms to follow up deformation of the rubber elastic body.

(1-1) In the configuration of (1) above, the inner circumferential surface of the holding hole is preferably shaped as a generally smooth curved surface. In the case of the stabilizer bushing of Patent Document 2, the lubricant is retained by the recess portion formed between the grid-like ribs. On the contrary, in the case of the stabilizer bushing of the present invention, the bleeding lubricant can be held by the coating film having permeability. Thus, the recess portion essential for the stabilizer bushing of Patent Document 2 is not necessary in the case of the stabilizer bushing of the present invention (however, a recess portion may be included in the configuration of (1) above).

In view of this point, the inner circumferential surface of the holding hole of the present configuration is shaped as a generally smooth curved surface (i.e., a curved surface without artificial unevenness). There is thus no need to form a recess portion on the inner circumferential surface of the holding hole.

In the case of the stabilizer bushing of Patent Document 2, a top portion of the grid-like ribs comes into sliding contact (linear contact) with the stabilizer bar. A relatively high pressure is applied by the stabilizer bar to the top portion of the rib. Therefore, the top portion of the rib is prone to wear, and the rubber elastic body consequently has low durability.

On the contrary, the inner circumferential surface of the holding hole of the present configuration is not formed with an unevenness. Therefore, the inner circumferential surface is in generally total surface contact with the stabilizer bar through the coating film and the lubricating film (and, depending on the case, only through the coating film). Thus, the rubber elastic body has high durability.

(2) In the configuration of (1) above, the coating film preferably further contains a solid lubricant (equivalent to claim 2). According to the present configuration, the friction resistance of the coating film itself is low with respect to the stabilizer bar. Therefore, even if there is a portion with an insufficient amount of the lubricating film of the stabilizer bushing on the sliding interface between the stabilizer bushing and the stabilizer bar, the friction resistance between the stabilizer bushing and the stabilizer bar can be reduced.

(3) In the configuration of (2) above, the solid lubricant is preferably made of polytetrafluoroethylene (equivalent to claim 3). Polytetrafluoroethylene has a particularly small friction coefficient even in a solid lubricant. Therefore, according to the present configuration, the friction resistance of the coating film itself with respect to the stabilizer bar can be further reduced.

(4) In the configuration of (3) above, the coating film preferably contains 200 parts by mass or less of the solid lubricant per 100 parts by mass of the resin (equivalent to claim 4). Here, the reason for including 200 parts by mass or less of the solid lubricant is because more than 200 parts by mass of the solid lubricant makes the coating film more susceptible to wear. In other words, because the durability of the coating film would decrease.

(4-1) In the configuration of (4) above, the coating film preferably includes 160 parts by mass or less of the solid lubricant, whereby the durability of the coating film can be maintained while reducing the friction resistance of the coating film with respect to the stabilizer bar.

(4-2) In the configuration of (4-1) above, the coating film preferably includes at least 110 and no more than 130 parts by mass of the solid lubricant. Here, the reason for including at least 110 parts by mass of the solid lubricant is because the friction resistance of the coating film with respect to the stabilizer bar increases if less than 110 parts by mass of the solid lubricant is included. Further, the reason for including no more than 130 parts by mass of the solid lubricant is because the coating film becomes more susceptible to wear if more than 130 parts by mass of the solid lubricant is included. According to the present configuration, the durability of the coating film can be maintained while reducing the friction resistance of the coating film with respect to the stabilizer bar.

(5) In the configuration of any one of (1) to (4) above, the resin is preferably a silicone resin (equivalent to claim 5). According to the present configuration, the coating film is formed with the silicone resin included. This facilitates penetration of the coating film by the bleeding lubricant of the rubber elastic body. Thus, the lubricating film can be surely formed on at least a portion of the surface of the coating film. In addition, the coating film is relatively flexible because the coating film is formed with the silicone resin included. Therefore, the coating film also easily deforms to follow up deformation of the rubber elastic body.

(6) In the configuration of (5) above, the silicone resin preferably has a less dense cross-linked structure than a straight silicone resin and a modified product thereof, and has rubber elasticity (equivalent to claim 6).

Here, a “straight silicone resin” refers to a silicone resin that includes only a methyl group, and a silicone resin that includes only a methylphenyl group. A “modified product of the straight silicone resin” includes an epoxy-modified silicone resin, an alkyd-modified silicone resin, a polyester-modified silicone resin, a silica-modified silicone resin, an acrylic-modified silicone resin, and the like. A silicone resin that “has rubber elasticity” includes a silicone resin mixed with rubber and a silicone resin with rubber elasticity that are used in a rubber coating agent or the like.

According to the present configuration, the cross-linked structure of the silicone resin is not dense, whereby the bleeding lubricant of the rubber elastic body can even more easily penetrate the coating film. Thus, the lubricating film can be even more surely formed on at least a portion of the surface of the coating film.

### Effect of the Invention

According to the present invention, a stabilizer bushing can be provided, wherein there is low friction resistance between the stabilizer bushing and a stabilizer bar and a coating film is not prone to separation from a rubber elastic body.

### BRIEF DESCRIPTION OF THE DRAWINGS

FIG. 1 is a layout drawing of a stabilizer bushing that serves as a first embodiment of a stabilizer bushing according to the present invention.

FIG. 2 is a composite perspective view of the stabilizer bushing and a bracket.

FIG. 3 is an exploded perspective view of the stabilizer bushing and the bracket.

FIG. 4 is a cross-sectional view in the direction of line IV-IV in FIG. 2.

FIG. 5 is an enlarged view of inside a box V in FIG. 4.

FIG. 6 is a schematic diagram of a suspension of a vehicle.

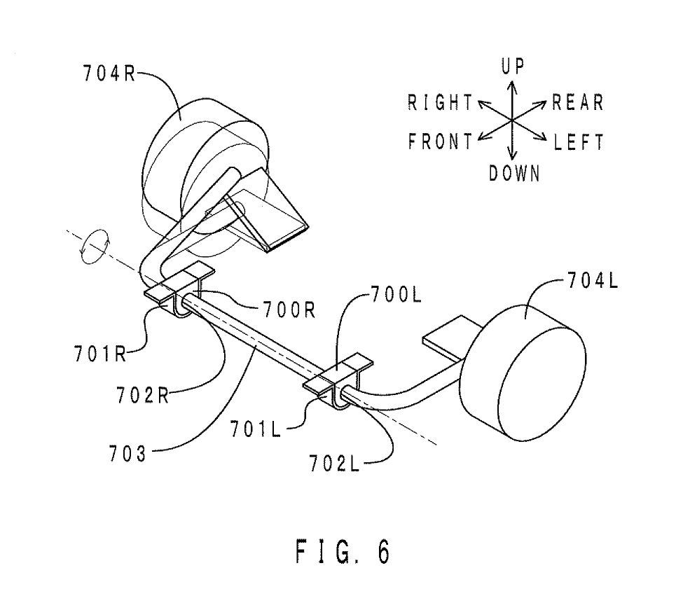

### DESCRIPTION OF EMBODIMENTS

Hereinafter, embodiments of a stabilizer bushing according to the present invention will be described.

[Stabilizer Bushing Layout]

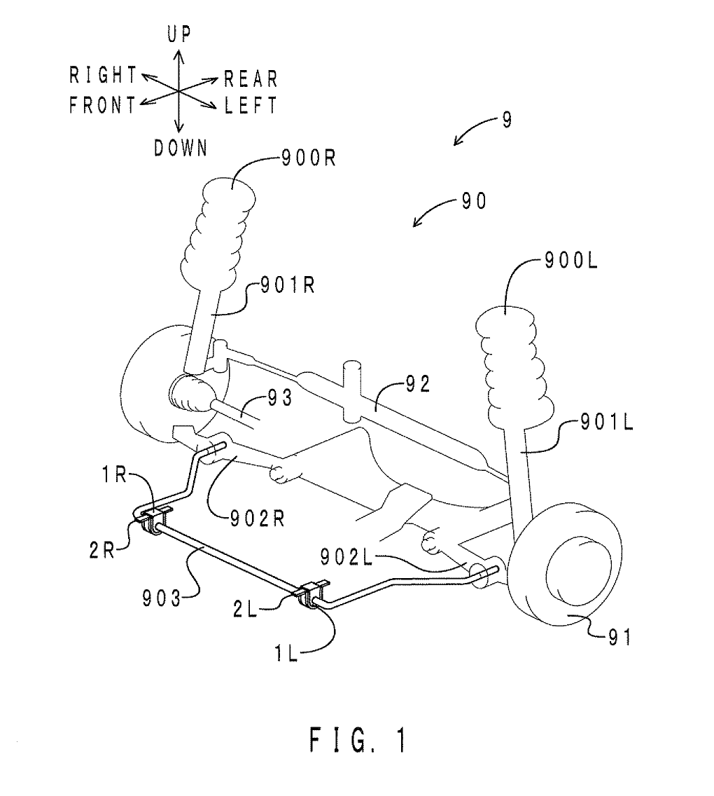

First, the layout of the stabilizer bushing according to the present embodiment will be described. FIG. 1 shows a layout drawing of the stabilizer bushing according to the present embodiment. As shown in FIG. 1, members including a suspension 90, a hub unit 91, a steering gear 92, and a drive shaft 93 are arranged in the vicinity of front wheels of a vehicle 9. The suspension 90 includes springs 900L, 900R, shock absorbers 901L, 901R, lower suspension arms 902L, 902R, a stabilizer bar 903, and the like. The stabilizer bar 903 is made of steel and has a long-axis pipe configuration that expands forward in a C shape. Both ends of the stabilizer bar 903 in the left-right direction are connected to the lower suspension arms 902L, 902R. Two left and right locations in a center portion of the stabilizer bar 903 are connected to a body (not shown) of the vehicle 9 through stabilizer bushings 1L, 1R and brackets 2L, 2R. Thus, the stabilizer bushings 1L, 1R are interposed between the stabilizer bar 903 and the body of the vehicle 9. The stabilizer bushings 1L, 1R suppress the transmission of vibrations input from the front wheels to the body of the vehicle 9 through the stabilizer bar 903.

[Stabilizer Bushing Structure]

Next, the structure of the stabilizer bushings 1L, 1R according to the present embodiment will be described. The two left and right stabilizer bushings 1L, 1R have identical structures. The structure of the left stabilizer bushing 1L will be explained below, and this description also serves to explain the structure of the right stabilizer bushing 1R.

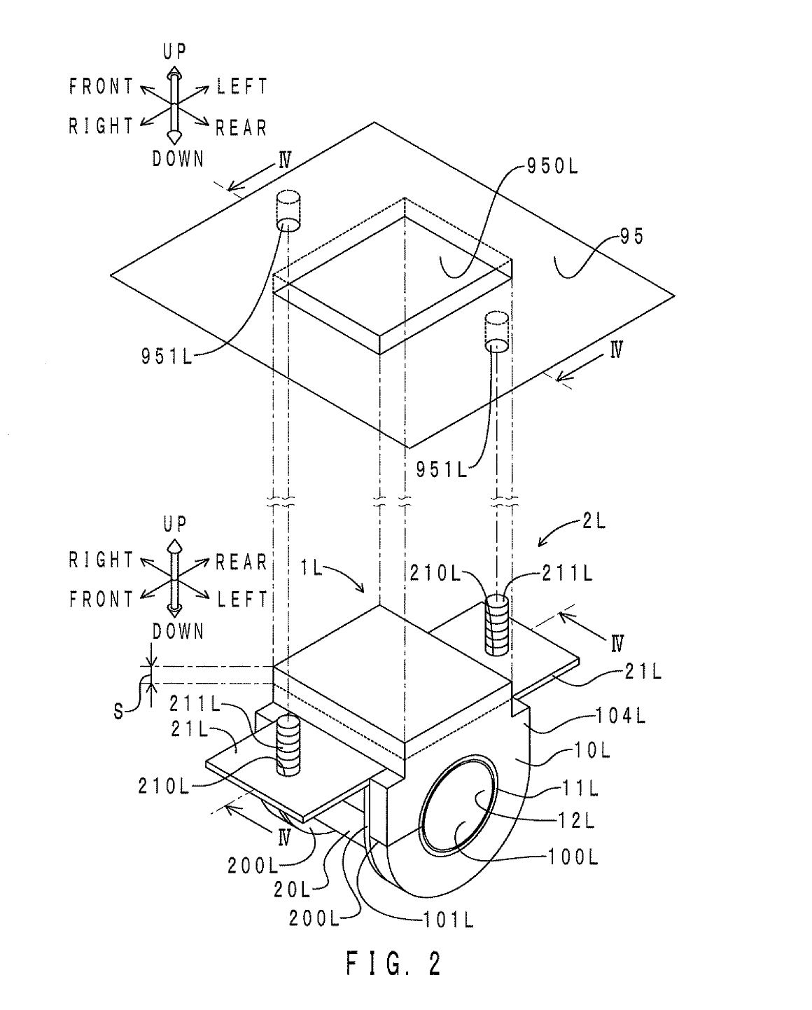

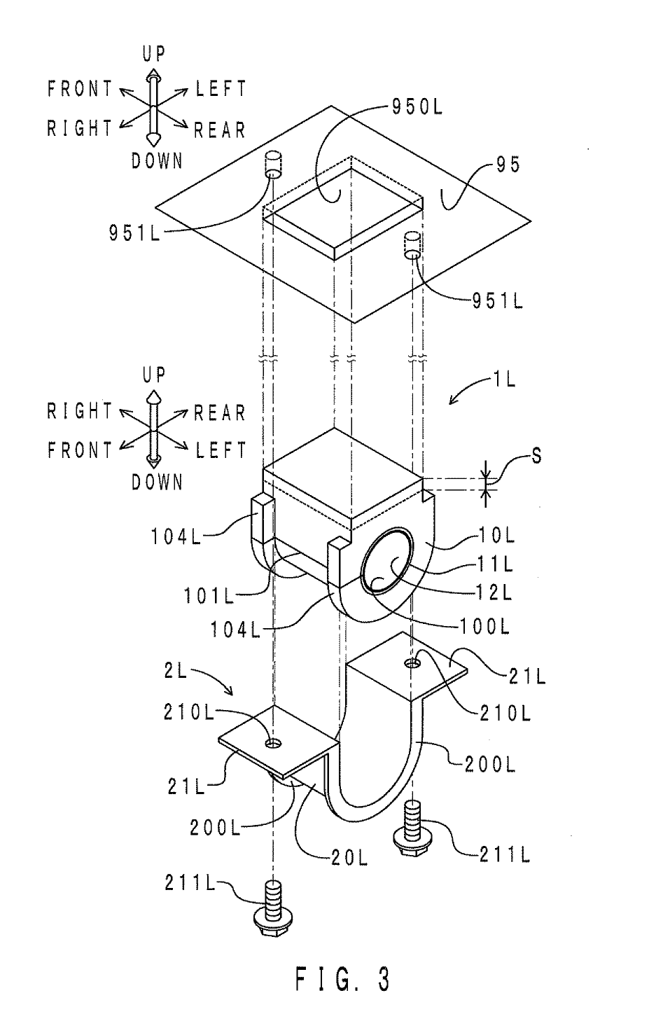

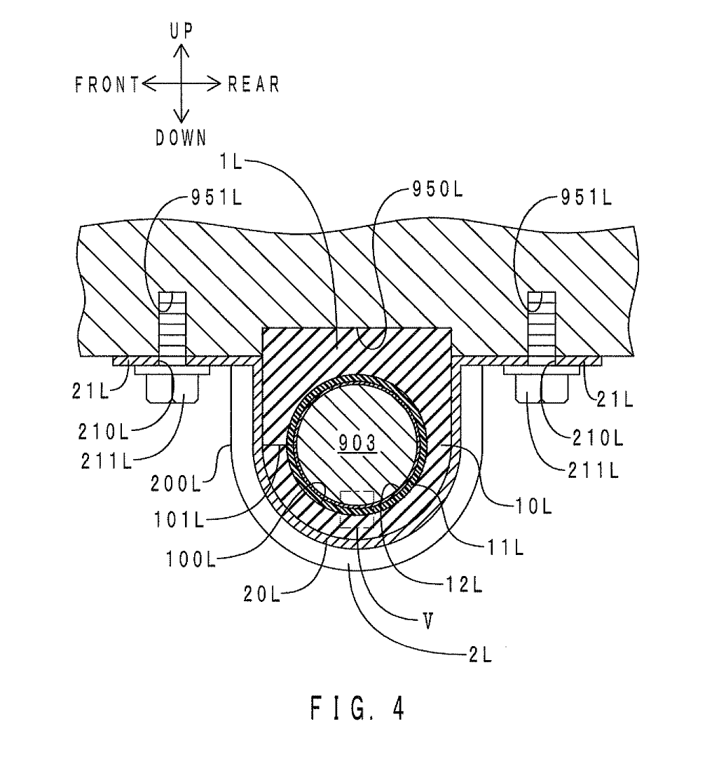

FIG. 2 shows a composite perspective view of the stabilizer bushing and the bracket according to the present embodiment. FIG. 3 shows an exploded perspective view of the stabilizer bushing and the bracket according to the present embodiment. FIG. 4 shows a cross-sectional view in the direction of a line IV-IV in FIG. 2. As shown in FIGS. 2 to 4, the stabilizer bushing 1L, of the present embodiment includes a rubber elastic body 10L, a coating film 11L, and a lubricating film 12L.

The rubber elastic body 10L has a solid U-shaped configuration when viewed from the left or right direction. In other words, an upper portion of the rubber elastic body 10L has a rectangular shape, and a lower portion of the rubber elastic body has a semicircular shape. The rubber elastic body 10L includes a holding hole 100L that passes through the rubber elastic body 10L in the left-right direction. The inner circumferential surface of the holding hole 100L has a predetermined curvature and is shaped as a generally smooth curved surface. In other words, the inner circumferential surface of the holding hole 100L is not formed with an artificial unevenness (e.g. the grid-like ribs of Patent Document 2). An outer portion of the rubber elastic body 10L and an inner portion of the holding hole 100L communicate through a cut portion 101L. The stabilizer bar 903 is disposed in the holding hole 100L. The stabilizer bar 903 is inserted from an outer portion of the rubber elastic body 10L into an inner portion of the holding hole 100L through an opening that is formed by opening the cut portion 101L in the up-down direction. Both left and right edges of the rubber elastic body 10L are formed with a pair of flange portions 104L. The pair of flange portions 104L each have U-shaped configurations that open upward.

The coating film 11L has a cylindrical shape. The coating film 11L covers the inner circumferential surface of the holding hole 100L. The coating film 11L has a thickness (radial thickness) of approximately 20 μm. The lubricating film 12L is in liquid form and covers the surface (inner circumferential surface) of the coating film 11L. The surface of the lubricating film 12L (the surface of the coating film 11L if the lubricating film 12L is insufficient) is in contact with the outer circumferential surface of the stabilizer bar 903.

[Stabilizer Bushing Material]

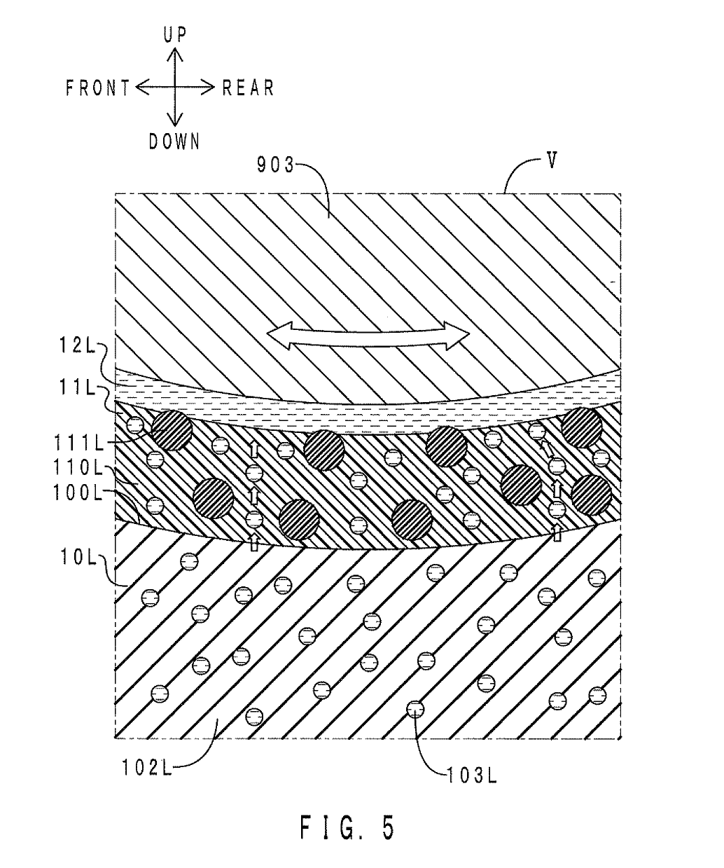

Next, the material of the stabilizer bushings 1L, 1R according to the present embodiment will be described. FIG. 5 shows an enlarged view of inside a box V in FIG. 4. Note that FIG. 5 is a schematic diagram for explaining a function of the stabilizer bushings 1L, 1R according to the present embodiment.

The rubber elastic body 10L is made of a self-lubricating rubber. The rubber elastic body 10L includes a blended rubber (referred to simply as a “blend rubber” below) 102L of a natural rubber (NR) and a butadiene rubber (BR); and an oleic acid amide 103L. The blend rubber 102L is included in the concept of an elastomer of the present invention. The oleic acid amide 103L is included in the concept of a bleeding lubricant of the present invention.

The coating film 11L (made of SOLVEST 398 from STT, Inc., for example) includes a silicone resin 110L having a mercapto group, and a solid lubricant 111L made of PTFE. 120 parts by mass of the solid lubricant 111L are included per 100 parts by mass of the silicone resin 110L. The solid lubricant 111L has a generally spherical shape with a particle diameter (median diameter) of approximately 1 μm or less, wherein the average particle diameter is approximately 0.5 μm.

The lubricating film 12L is formed by the oleic acid amide 103L of the rubber elastic body 10L. That is, the oleic acid amide 103L of the rubber elastic body 10L penetrates the coating film 11L, as shown by white arrows in FIG. 5. The oleic acid amide 103L then oozes onto the surface of the coating film 11L. The lubricating film 12L is thus formed by the oleic acid amide 103L that oozed out.

As shown by the white double-ended arrows in FIG. 5, the stabilizer bar 903 twists around an axis in accordance with the behavior of the vehicle 9. Meanwhile, the stabilizer bushing 1L is fixed to the body of the vehicle 9 through the bracket 2L that will be described later. Therefore, the surface of the lubricating film 12 (the surface of the coating film 11L if the lubricating film 12L is insufficient) is relatively in sliding contact with the outer circumferential surface of the stabilizer bar 903.

[Bracket Structure]

Next, the structure of the brackets 2L, 2R according to the present embodiment will be described. The two left and right brackets 2L, 2R have identical structures. The structure of the left bracket 2L will be explained below, and this description also serves to explain the structure of the right bracket 2R. As shown in FIGS. 2 to 4, the bracket 2L of the present embodiment is made of steel and includes a bushing support portion 20L, and a pair of fixing portions 21L.

The bushing support portion 20L has a U-shaped configuration that opens upward when viewed from the left or right direction. Both left and right edges of the bushing support portion 20L are formed with a pair of flange portions 200L. A portion between the pair of flange portions 104L of the stabilizer bushing 1L is accommodated in an inner portion of the U-shaped opening of the bushing support portion 20L. The inner sides in the left-right direction of the pair of flange portions 104L contact the pair of flange portions 200L. Through such contact, separation of the stabilizer bushing 1L from the bracket 2L in the left-right direction can be suppressed.

Each of the pair of fixing portions 21L has a rectangular plate configuration. The pair of fixing portions 21L continues from both ends of the U-shaped bushing support portion 20L. A bolt insertion hole 210L is provided in each of the pair of fixing portions 21L, and a bolt 211L is inserted from below into each of the pair of bolt insertion holes 210L. Meanwhile, a recess portion 950L and a pair of bolt securing holes 951L are disposed on the lower surface of a body 95 of the vehicle 9. The space in an inner portion of the recess portion 950L has a cubic shape. The upper portion of the stabilizer bushing 1L is inserted into the recess portion 950L. The pair of bolt securing holes 951L is arranged in the front-rear direction of the recess portion 950L. The bolt 211L passes through the bolt insertion hole 210L and is threadedly fastened in the bolt securing hole 951L. Thus, the bracket 2L is fixed to the lower surface of the body 95 by the pair of bolts 211L. In addition, the stabilizer bushing 1L is held and fixed between the bracket 2L and the lower surface of the body 95. During such fixing, the upper portion of the rubber elastic body 10L is compressed and deformed by a fastening amount S (see FIGS. 2 and 3). Through the fastening amount S, the stabilizer bushing 1L is in press-contact with the outer circumferential surface of the stabilizer bar 903.

[Stabilizer Bushing Production Method]

Next, the production method of the stabilizer bushings 1L, 1R according to the present embodiment will be described. The production method for the two left and right stabilizer bushings 1L, 1R is the same. The production method of the left stabilizer bushing 1L will be explained below, and this description also serves to explain the production method of the right stabilizer bushing 1R.

The production method of the stabilizer bushings 1L, 1R according to the present embodiment includes a composition preparation process, a cross-linking process, a degreasing process, a coating process, and a baking process. In the composition preparation process, a composition is prepared by mixing together a base material of the blend rubber 102L, the oleic acid amide 103L, a cross-linking agent, and the like.

In the cross-linking process, the composition is injected into a cavity of a closed mold, and the base material of the blend rubber 102L inside the cavity undergoes a cross-linking reaction. Thereafter, the mold is opened and the rubber elastic body 10L is retrieved from the cavity. Next, a cut portion 101L (see FIG. 4) is formed in the rubber elastic body 10L. It should be noted that the oleic acid amide 103L oozes onto the inner circumferential surface of the holding hole 100L of the rubber elastic body 10L.

In the degreasing process, the inner circumferential surface of the holding hole 100L of the rubber elastic body 10L is degreased using isopropyl alcohol (IPA). The oleic acid amide 103L is then removed from the inner circumferential surface of the holding hole 100L.

In the coating process, the inner circumferential surface of the cleaned holding hole 100L is coated with a coating. The coating contains a base material of the silicone resin 110L having a mercapto group, and the solid lubricant 111L made of PTFE.

In the baking process, the rubber elastic body 10L coated with the coating is baked. Baking thermally hardens the base material of the silicone resin 110L having a mercapto group. The coating film 11L is thus formed on the inner circumferential surface of the holding hole 100L. The oleic acid amide 103L of the rubber elastic body 10L penetrates the coating film 11L formed. The lubricating film 12L is subsequently formed on the surface of the coating film 11L by the oleic acid amide 103L that penetrated the coating film 11L. Thus, the stabilizer bushing 1L according to the present embodiment is produced.

[Operation and Effects]

Next, the operation and effects of the stabilizer bushings 1L, 1R according to the present embodiment will be described. The lubricating film 12L of the stabilizer bushings 1L, 1R according to the present embodiment is in sliding contact with the stabilizer bar 903. In addition, for example, if a portion without a sufficient lubricating film 12L becomes part of the sliding interface between the stabilizer bushings 1L, 1R and the stabilizer bar 903 due to a temporary lack of the lubricating film 12L or the like, the coating film 11L is exposed from the portion and in sliding contact with the stabilizer bar 903. In other words, even if the lubricating film 12L is insufficient, the coating film 11L that contains the oleic acid amide 103L and the solid lubricant 111L is in sliding contact with the stabilizer bar 903. Thus, according to the stabilizer bushings 1L, 1R of the present embodiment, the lubricating film 12L normally is in sliding contact with the stabilizer bar 903. If the lubricating film 12L is insufficient, however, the coating film 11L is in sliding contact with the stabilizer bar 903. In addition, the rubber elastic body 10L is not in sliding contact with the stabilizer bar 903. Thus, there is low friction resistance between the stabilizer bushings 1L, 1R and the stabilizer bar 903.

A mercapto group (—SH) is introduced to the silicone resin 110L that forms the coating film 11L. The mercapto group is a functional group with high reactivity towards an elastomer. Therefore, according to the stabilizer bushings 1L, 1R of the present embodiment, the rubber elastic body 10L and the coating film 11L can be strongly joined (chemically bonded). Therefore, the coating film 11L is not prone to separation from the rubber elastic body 10L. The coating film 11L also easily deforms to follow up deformation of the rubber elastic body 10L. In addition, the solid lubricant 111L is made of PTFE having a particularly small friction coefficient. Thus, in consideration of this point as well, the coating film 11L of the stabilizer bushings 1L, 1R according to the present embodiment has low friction resistance with respect to the stabilizer bar 903.

According to the stabilizer bushings 1L, 1R of the present embodiment, 120 parts by mass of the solid lubricant 111L are included per 100 parts by mass of the silicone resin 110L. Therefore, the durability of the coating film 11L can be upheld while also reducing the friction resistance of the coating film 11L with respect to the stabilizer bar 903.

According to the stabilizer bushings 1L, 1R of the present embodiment, the resin that forms the coating film 11L is the silicone resin 110L. This facilitates penetration of the oleic acid amide 103L of the rubber elastic body 10L through the coating film 11L. Therefore, the lubricating film 12L can be surely formed on the surface of the coating film 11L. In addition, the coating film 11L is relatively flexible because the coating film 11L is formed with the silicone resin 110L included. Therefore, in consideration of this point as well, the coating film 11L easily deforms to follow up deformation of the rubber elastic body 10L.

The silicone resin 110L that forms the coating film 11L (made of SOLVEST 398 from STT, Inc., for example) is a silicone resin with rubber elasticity. The silicone resin 110L, has a less dense cross-linked structure than a straight silicone resin and a modified product thereof, and the silicone resin 110L has rubber elasticity. This further facilitates penetration of the oleic acid amide 103L of the rubber elastic body 10L through the coating film 11L. Thus, the lubricating film 12L can be even more surely formed.

According to the stabilizer bushings 1L, 1R of the present embodiment, the oleic acid amide 103L can be retained by the coating film 11L having permeability. There is thus no need to form a recess portion for retaining the oleic acid amide 103L on the rubber elastic body 10L as with the stabilizer bushing of Patent Document 2 above.

According to the stabilizer bushings 1L, 1R of the present embodiment, the interface between the rubber elastic body 10L and the coating film 11L has a micro uneven configuration. In other words, at the interface, the rubber elastic body 10L and the coating film 11L mutually interlock. Therefore, due to a so-called “anchor effect”, the rubber elastic body 10L and the coating film 11L can be strongly joined together.

### Other Embodiments

An embodiment of the stabilizer bushing according to the present invention was described above. However, the embodiments of the present invention are not particularly limited to the mode described above; various modifications and improvements may also be implemented by a person having ordinary skill in the art.

The rubber elastic body 10L is not particularly limited in terms of elastomer material. For example, NR, BR, isoprene rubber (IR), styrene-butadiene rubber (SBR), chloroprene rubber (CR), nitrile butadiene rubber (NBR), ethylene-propylene rubber (EPDM), butyl rubber (IIR), acrylic rubber (ACM), urethane rubber (U), silicone rubber, any blend material of these rubbers, and the like may be used.

The bleeding lubricant of the rubber elastic body 10L is not particularly limited in terms of material. For example, a fatty acid amid (an unsaturated fatty acid amide (oleic acid amide, erucic acid amide, or the like), a saturated fatty acid amide (stearic acid amide, behenic acid amide, or the like), a silicone oil, a polyethylene glycol surfactant, and the like may be used.

The resin of the coating film 11L is not particularly limited in terms of material. For example, polyester, acrylic, urethane, and the like may be used.

The solid lubricant 111L of the coating film 11L is not particularly limited in terms of material. For example, graphite, molybdenum disulfide, fluorine resin, and the like may be used. Examples of the fluorine resin include a tetrafluoroethylene-perfluoroalkoxy vinyl ether copolymer (PFA), a tetrafluoroethylene-hexafluoropropylene copolymer (FEP), polychlorotrifluoroethylene (PCTFE), a tetrafluoroethylene-ethylene copolymer (ETFE), a chlorotrifluoroethylene-ethylene copolymer (ECTFE), polyvinylidene fluoride (PVDF), polyvinyl fluoride (PVF), and the like.

### Examples

Hereinafter, a torque test performed on the stabilizer bushing of the present invention will be described.

[Samples]

As samples to be used in the test, the stabilizer bushing 1L (see FIGS. 2 to 5) according to the above embodiment was set with 4 different amounts of the solid lubricant 111L of the coating film 11L.

Example 1 had 0 parts by mass of the solid lubricant 111L per 100 parts by mass of the silicone resin 110L. Example 2 had 120 parts by mass of the solid lubricant 111L per 100 parts by mass of the silicone resin 110L (i.e., Example 2 is the stabilizer bushing 1L of the above embodiment). Example 3 had 160 parts by mass of the solid lubricant 111L per 100 parts by mass of the silicone resin 110L. Example 4 had 200 parts by mass of the solid lubricant 111L per 100 parts by mass of the silicone resin 110L. A sample of only the rubber elastic body 10L (without the coating film 11L or the lubricating film 12L) was used as a Comparative Example.

[Test Method]

First, each sample was fixed to a jig (equivalent to the lower surface of the body 95 of the vehicle 9 according to the above embodiment) by the bracket 2L. Next, a shaft (equivalent to the stabilizer bar 903 of the above embodiment) was inserted into the holding hole 100L of each sample. Using a torque wrench, the shaft was subsequently twisted by ±15 degrees around an axis. The torsional torque applied to the shaft was then measured. If the friction resistance between the shaft and the sample is low, the torsional torque applied to the shaft will be small. Conversely, if the friction resistance between the shaft and the sample is high, the torsional torque applied to the shaft will be large.

[Test Results]

If the torsional torque of the Comparative Example is considered to be 100%, the torsional torque of Example 1 was 23%, the torsional torque of Example 2 was 25%, the torsional torque of Example 3 was 42%, and the torsional torque of Example 4 was 55%. It was thus found that the torsional torque of Examples 1 to 4 was smaller than that of the Comparative Example. In other words, there was less friction resistance between the sample and the shaft in Examples 1 to 4 than in the Comparative Example.

### DESCRIPTION OF THE REFERENCE NUMERALS

1L: stabilizer bushing, 1R: stabilizer bushing, 2L: bracket, 2R: bracket, 9: vehicle

10L: rubber elastic body, 11L: coating film, 12L: lubricating film, 20L: bushing support portion, 21L: fixing portion, 90: suspension, 91: hub unit, 92: steering gear, 93: drive shaft, 95: body

100L: holding hole, 101L: cut portion, 102L: blend rubber (elastomer), 103L: oleic acid amide (bleeding lubricant), 104L: flange portion, 110L: silicone resin, 111L: solid lubricant, 200L: flange portion, 210L: bolt insertion hole, 211L: bolt, 900L: spring, 900R: spring, 901L: shock absorber, 901R: shock absorber, 902L: lower suspension arm, 902R: lower suspension arm, 903: stabilizer bar, 950L: recess portion, 951L: bolt securing hole

S: fastening amount

1. A stabilizer bushing, comprising:
a rubber elastic body that is made of a self-lubricating rubber containing an elastomer and a bleeding lubricant, that includes a holding hole that holds a stabilizer bar on a radial inner side, and that is shaped as a cylinder attached to a body of a vehicle by a bracket;
a coating film that covers an inner circumferential surface of the holding hole, that contains a resin having a mercapto group, and that is deformable to follow up deformation of the rubber elastic body; and
a lubricating film that is formed on a surface of the coating film by the bleeding lubricant of the rubber elastic body penetrating the coating film and oozing onto the surface of the coating film, and that is in relative sliding contact with an outer circumferential surface of the stabilizer bar.

2. The stabilizer bushing according to claim 1, wherein the coating film further contains a solid lubricant.

3. The stabilizer bushing according to claim 2, wherein the solid lubricant is made of polytetrafluoroethylene.

4. The stabilizer bushing according to claim 3, wherein the coating film contains 200 parts by mass or less of the solid lubricant per 100 parts by mass of the resin.

5. The stabilizer bushing according to claim 1, wherein the resin is a silicone resin.

6. The stabilizer bushing according to claim 5, wherein the silicone resin has a less dense cross-linked structure than a straight silicone resin and a modified product thereof, and has rubber elasticity.

7. The stabilizer bushing according to claim 2, wherein the resin is a silicone resin.

8. The stabilizer bushing according to claim 3, wherein the resin is a silicone resin.

9. The stabilizer bushing according to claim 4, wherein the resin is a silicone resin.

10. The stabilizer bushing according to claim 7, wherein the silicone resin has a less dense cross-linked structure than a straight silicone resin and a modified product thereof, and has rubber elasticity.

11. The stabilizer bushing according to claim 8, wherein the silicone resin has a less dense cross-linked structure than a straight silicone resin and a modified product thereof, and has rubber elasticity.

12. The stabilizer bushing according to claim 9, wherein the silicone resin has a less dense cross-linked structure than a straight silicone resin and a modified product thereof, and has rubber elasticity.
